(19) United States
(12) Patent Application Publication
(10) Pub. No.: US 2011/0024240 A1
(43) Pub. Date: Feb. 3, 2011

(54) ARRANGEMENT FOR THE CALL APPARATUS AND DISPLAY APPARATUS OF AN ELEVATOR

(75) Inventors: Niko Rusanen, Helsinki (FI); Timo Tiainen, Vantaa (FI); Maija Pursiainen, Vantaa (FI); Jussi Laurila, Vantaa (FI); Aapo Saari, Espoo (FI)

Correspondence Address: BIRCH STEWART KOLASCH & BIRCH, PO BOX 747, FALLS CHURCH, VA, 22040-0747, US

(73) Assignee: KONE CORPORATION, Helsinki (FI)

(21) Appl. No.: 12/829,967

(22) Filed: Jul. 2, 2010

Related U.S. Application Data
(63) Continuation of application No. PCT/FI2009/000024, filed on Feb. 10, 2009.

(30) Foreign Application Priority Data
Feb. 11, 2008 (FI) 20080094

(51) Int. Cl. B66B 1/34

(52) U.S. Cl. 187/395

(57) ABSTRACT

The object of the invention is an arrangement for the call apparatus and display apparatus of an elevator. The arrangement (1, 17) comprises a body part (5, 18), which comprises at least call buttons (8) and other actuators (3), such as apertures (6, 7, 19) for the display elements (16). The body part (5, 18) is essentially universal such that the number, size, shape and placement location of the apertures (6, 7, 19) of the body part (5, 18) are arranged to be suited for the use of as many display variations and/or call button variations as possible, and in that an essentially thin light-attenuating film-like layer (9, 20) is disposed in front of the body part (5, 18), which layer is fitted to allow light produced by the display elements through, but covers the apertures (6, 7, 19) and other features in the body part (5, 18).

The present invention relates to an arrangement for the call apparatus and display apparatus of an elevator as defined in the preamble of claim 1.

Elevators normally contain call apparatuses on the floor levels, such as e.g. call pushbuttons, with which a call is sent for receiving an elevator at the floor in question and correspondingly elevator cars contain call apparatuses for sending the elevator car to the desired destination floor. In addition, the floor levels and elevator cars often contain display apparatuses for displaying different information, such as at least floor information. For various reasons many structural solutions that are different both visually and in their layout are used on both floor levels and in elevator cars, which solutions comprise e.g. a different number of pushbuttons and displays as well as displays of different sizes.

A drawback with these prior-art call apparatuses and display apparatuses is that they are inflexible with respect to changes. For example, a different body part corresponding to exactly the amount of call buttons in question and to their placement is needed for each amount of call buttons, which body part comprises apertures of suitable sizes and correct positioning for the lead-throughs of the call buttons. There is also the same problem if it is desired to replace the display. The body part and other components of the apparatus are dimensioned specifically for a certain display, in which case in order to change the display to a different one, at least a body part and possibly other components of the apparatus must be changed.

The purpose of this invention is to eliminate the aforementioned drawbacks and to achieve a simple and inexpensive arrangement for the call apparatus and display apparatus of an elevator, which arrangement can easily be configured to correspond to the needs of different buildings and of different groups of users. Additionally the purpose of the invention is to achieve an arrangement for the call apparatus and display apparatus of an elevator that enables a number of different call button layouts and display layouts and also color layouts. Additionally the purpose of the invention is to achieve an arrangement in which one, or only a few, universal, i.e. generic, body part is used, into which different call button variations and display variations can be disposed, and the shapes of the apertures and holes of which can be covered from sight. The arrangement according to the invention is characterized by what is disclosed in the characterization part of claim 1. Other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment of the invention can also be applied in other embodiments.

One advantage of the arrangement according to the invention is that call apparatuses and display apparatuses that are different in their appearance but uniform in their style are flexibly and easily achieved. Another advantage is that only one or a few universal body parts can be used, into which different call button variations, display variations and other desired functions can easily be combined. Yet another advantage is that any graphics whatsoever can be printed on the film used, so that the basic color and basic pattern of the call apparatuses and display apparatuses, as well as texts giving different information, can easily be changed if necessary. Another advantage is that various functions, such as a video camera, RFID identifiers, etc, can easily be obtained behind a covering film for the display.

In the following, the invention will be described in more detail by the aid of two different examples of its embodiment with reference to the attached drawings, wherein

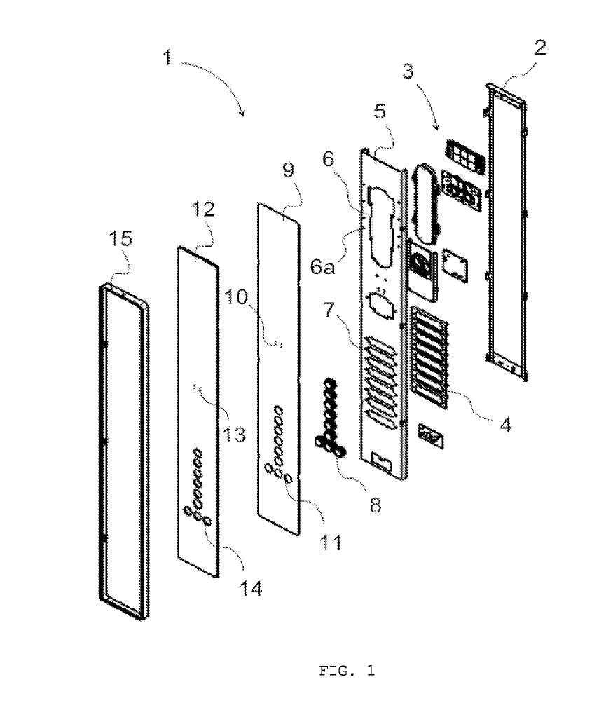

FIG. 1 presents as an explosion drawing an oblique top view of one call apparatus and display apparatus according to the invention in the elevator car,

FIG. 1a presents a simplified cross-section of the frame,

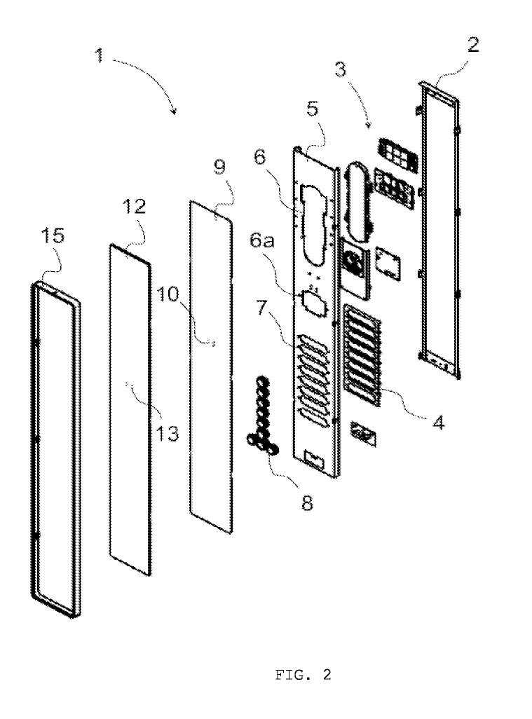

FIG. 2 presents as an explosion drawing an oblique top view of a second call apparatus and display apparatus according to the invention in the elevator car,

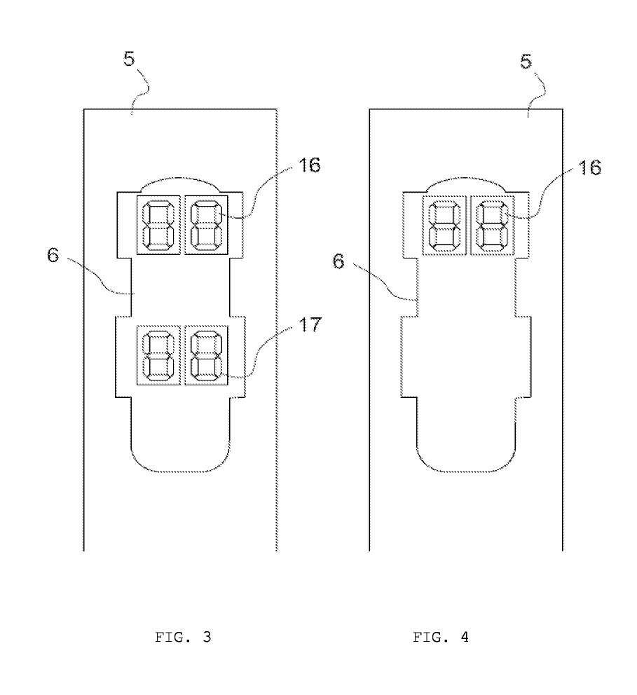

FIG. 3 presents a front view of the top end of one body part of a call apparatus and display apparatus according to the invention provided with two display elements,

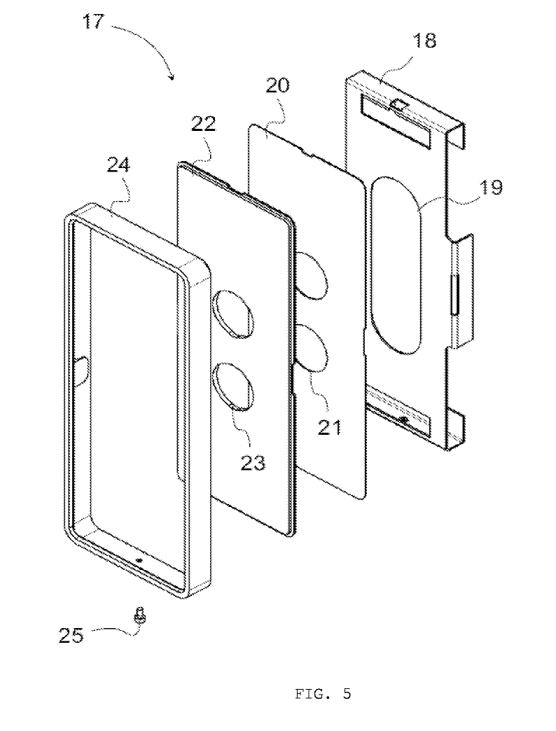

FIG. 4 presents a front view of the top end of one body part of a call apparatus and display apparatus according to the invention provided with one display element,

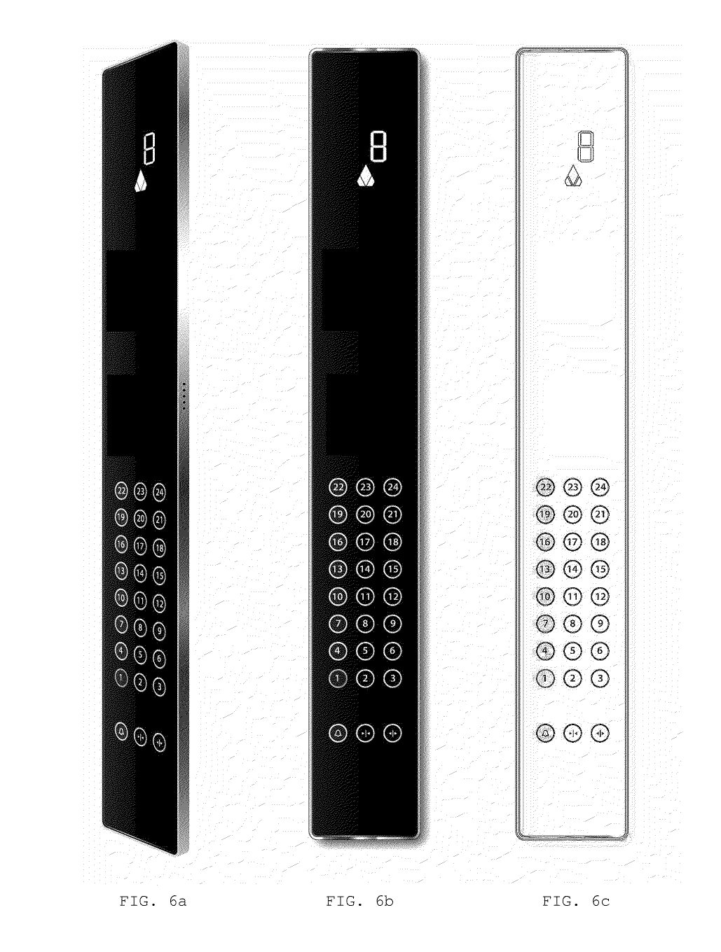

FIG. 5 presents as an explosion drawing an oblique top view of one call apparatus and display apparatus according to the invention on the floor level,

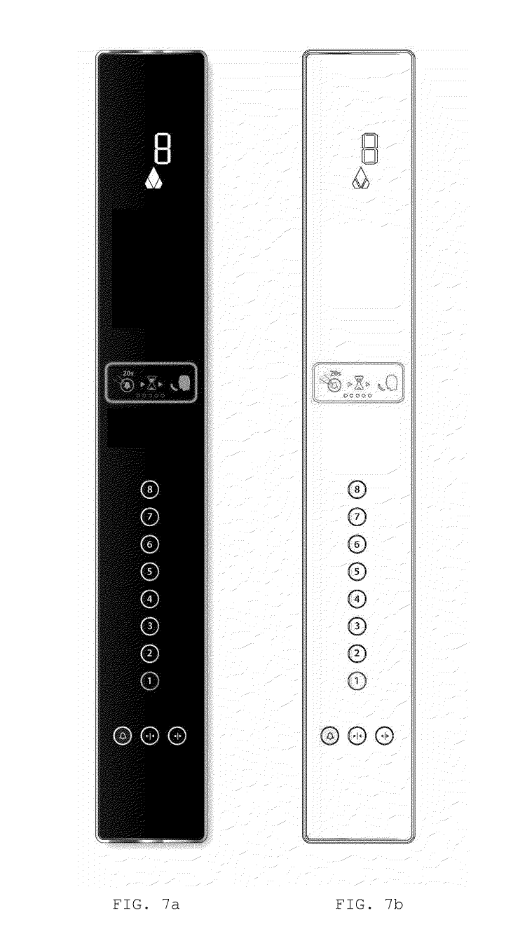

FIGS. 6a, 6b and 6c present an oblique side view and also a front view of a call apparatus and display apparatus according to the invention to be disposed in the elevator car,

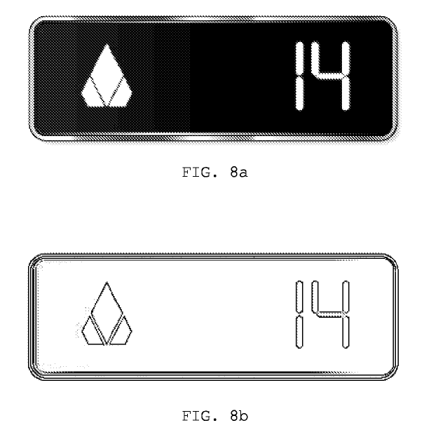

FIGS. 7a and 7b present a front view of a second call apparatus and display apparatus according to the invention to be disposed in the elevator car,

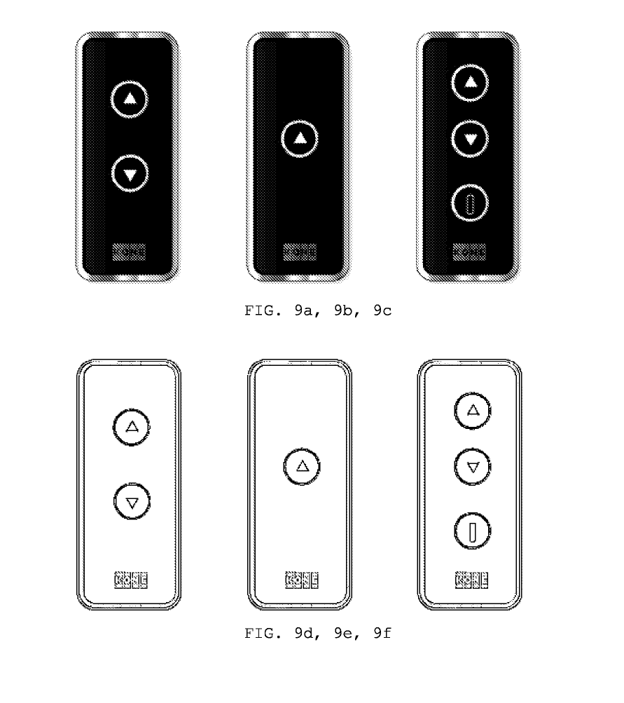

FIGS. 8a and 8b present a front view of a display apparatus according to the invention to be disposed in the elevator lobby,

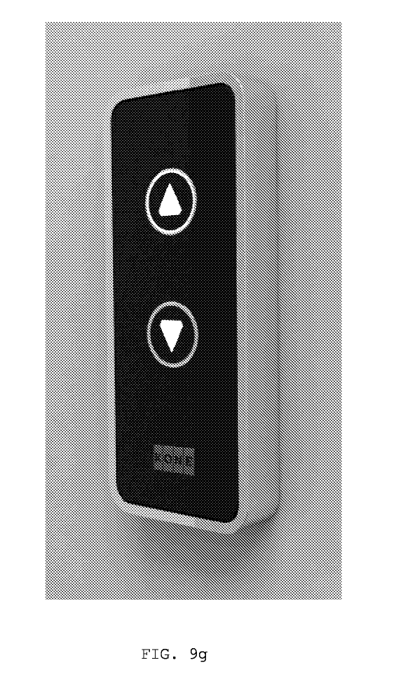

FIGS. 9a, 9b, 9c, 9d, 9,e and 9f present a front view of some call apparatuses and display apparatuses according to the invention to be disposed in the elevator lobby,

FIG. 9g presents an oblique side view of a call apparatus and display apparatus according to the invention to be disposed in the elevator lobby, and

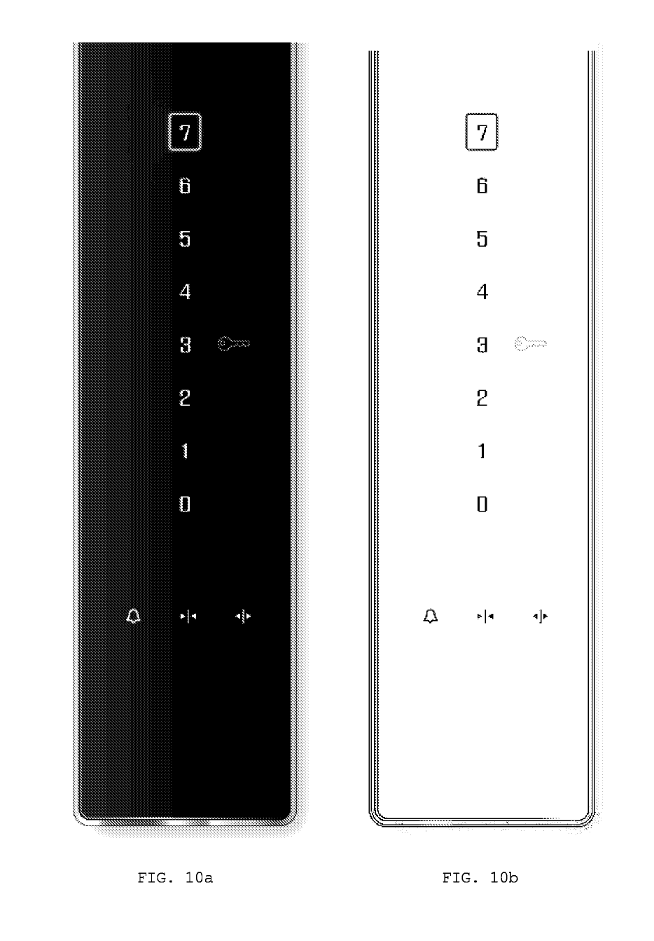

FIGS. 10a and 10b present a front view of the bottom part of a call apparatus and display apparatus according to the invention, in which the call buttons are touch buttons.

FIG. 1 presents as an explosion drawing a partly simplified oblique top view of one call apparatus and display apparatus 1, i.e. a car call panel, according to the invention in the elevator car. The car call panel 1 comprises at least a rearmost wall fixing support 2, which is fixed to the wall of the elevator car and correspondingly in connection with which the other parts of the car call panel are fixed. The car call panel 1 also comprises an essentially supportive body part 5, which is made e.g. of metal and which comprises different apertures 6, 7 and fixing holes 6a for the electronics and other actuators 3 of the car call panel. The majority of the actuators 3, such as the displays, microphone, loudspeaker, fixing frames 4 of the call buttons and other corresponding actuators, of the car call panel are fixed to the body part 5 and disposed between the wall fixing support 2 and the body part 5 such that the components of the actuators 3 that are desired to be visible are visible or extend through the apertures 6, 7. For example, the call buttons 8 are fitted to extend from the apertures 7 of the body part 5 through to the front side of the body part 5. In front of the body part 5 is an essentially thin body-tinted film or thin sheet 9, which comprises apertures 10 for the loudspeaker and if necessary also for the microphone as well as apertures 11 for the call buttons 8 used in this specific application. Further, in front of the film 9 is an essentially transparent support plate 12 of corresponding size to but thicker than the film 9, which support plate comprises apertures 13 for the loudspeaker, and if necessary for the microphone, that essentially correspond to the apertures 10 and 11 in the film 9 as well as apertures 14 for the call buttons 8 used in this specific application. Outermost in the car call panel 1 is a frame 15, inside which the aforementioned components can be disposed, and which is fitted to press, with the inner surface (15a, FIG. 1a) of its front edge, the support plate 12 and all the components behind it towards the body part 5 and the wall fixing support 2, to which the frame 15 can be fixed as invisibly as possible. The frame 15 compresses the car call panel 1 to its normal operating size and surrounds it from the sides, from below and partly also from the front, thus forming a uniform package.

What is essential to the arrangement according to the invention is, among other things, that the light permeability of the film 9 in front of the body part 5 is selected suitably, taking into account the strength of the light produced by the display of the display elements that are the actuators 3, and the strength of the ambient light affecting the car call panel 1, e.g. the strength of the inner lights of the elevator car. The light permeability of the film 9 is selected to be such that the light produced by the displays of the display elements that are the actuators 3 essentially permeates the film 9, while on the other hand the ambient light affecting the car call panel 1 is attenuated sufficiently to cover the apertures and actuators behind the film 9 from the sight of the passengers in the elevator car. In this case the light produced by the display of the display element can thus be seen as more powerful than the ambient light at the same time as the film 9 covers all other features of the body part under it from the passengers, except the signs produced with the light in the one or more displays. The film 9 can be manufactured as a separate, replaceable film or it can be printed on the rear surface of the support plate (12).

As a result of the foregoing, what is further essential to the arrangement according to the invention is that the body part 5 could be made to be essentially universal, in which case only a few, or in the best case only one, body part 5 is needed for all, at least the most common, options for the number, size and placement of the actuators 3. In this case the number, size, shape and placement location of the apertures 6, 7 and fixing holes 6a of the body part 5 is fitted to be such that e.g. there can be one or more displays, they can be of different sizes and their placement location in the top part of the body part can within certain limits be varied. Likewise there can be a different amount of the call buttons 8 and they can be in different places than what is presented in the embodiment according to FIG. 1. The apertures 7 of the body part 5 that are made for the call buttons 8 are the width of a number of call buttons and the shape of the apertures 7 is selected such that the call buttons 7 can be threaded through the apertures at many different points in the lateral direction. In this case the call buttons 8 can be 2, 3 or 4 or even more abreast, in addition to one vertical row. In this way different call button matrixes can be made using, however, the same body plate 5. The matrix can be e.g. two or three vertical rows of call buttons, below which is the row of three special buttons presented in FIG. 1, which special buttons are e.g. the opening and closing buttons of the doors and also a stop button. The call buttons 8 can also be disposed such that at some point above the bottom row there are more or less abreast than at the other points. In this case e.g. there can be a number of call buttons 8 for some floor that however are marked to convey to different rooms. The film 9 covers the apertures 7 that remain unused, so that the visual appearance of the car call panel 1 is always finished and neat.

The light permeability of the film 9 is influenced by the thickness and the color of the film. Generally speaking, less light passes permeates through dark colors than light colors. The film 9 can be wholly of the same color and uniform in its permeability throughout the whole area of the film or the film can also be different in its permeability in different points of the film. Differences in permeability can be implemented with different colors or e.g. with variations in the thickness of the color layer.

In addition to the permeability of light, different graphics, patterns and decorations are made on the film 9 with different colors. The car call panels 1 provided with films of different colors and different patterns can thus be fitted preferably as a visually suitable entity with respect to the other interior decor of the elevator car and/or can be selected on the basis of the wishes of customers. Different texts and other information can also be printed onto the film. For example, information concerning certain floors, and e.g. in the aforementioned case, in which a number of call buttons 8 are marked to convey to the same floor, the film 9 can be printed with the additional information applying to these call buttons.

As mentioned earlier, it is possible to conceal different actuators, which are not desired to be visible either for aesthetic reasons or for other reasons such as owing to the risk of vandalism, behind the film 9. These types of actuators can be e.g. a video camera, RFID identifiers, etc.

FIG. 2 presents a second call apparatus and display apparatus according to the invention in the elevator car, i.e. a car call panel 1. This differs from the car call panel according to FIG. 1 in that the call buttons 8 are touch buttons or call buttons that react to a light touch in some other corresponding way, which do not need to be mechanically moved, so that they are not fitted to pass through the film 9 and the support plate 12. In this case both the film 9 and the support plate 12 are intact at the point of the call buttons 8. In the manner of FIG. 1, the film 9 of FIG. 2 can be a separate, replaceable film or it can be printed on the rear surface of the support plate 9.

FIGS. 3 and 4 present two different display variations. The solution according to FIG. 3 comprises two display elements 16 and 17, one above the other, both of which are suited to the large and appropriately shaped aperture 6 in the body part 5. Correspondingly, FIG. 4 comprises only one display element 16, which in the figure is disposed in the top part of the aperture 6 but could just as well be also in the bottom part of the aperture 6. Although the display elements 16, 17 presented are similar in the figures and are based on so-called seven-segments technology, they can be also be of different models and based on different display technologies.

FIG. 5 presents one call apparatus and display apparatus, i.e. a call button panel 17, according to the invention in the elevator lobby, which apparatus comprises at least a universal body part 18, which comprises at least one aperture 19 for the actuators, such as the pushbuttons and indicator arrows or corresponding, of the call button panel 17. In front of the body part 17 is an essentially thin film 20 corresponding at least in its permeability characteristics to the film 9, and in front of this is an essentially transparent support plate 22 corresponding to the support plate 12. The film 20 and the support plate 22 comprise apertures 21 and 23 corresponding to the actuators disposed in the call button panel 17, which in this example are apertures intended for call buttons. Outermost in the call button panel 17 is a frame 24, corresponding to the frame 15, which is fitted to enclose the body part 18, the film 20 and the support plate 22 inside it such that only the center part of the frame 24 is open. The frame 24 is fixed to the body part 18 by means of one or more fixing screws 25 or corresponding fixing elements.

It is obvious to the person skilled in the art that the invention is not limited solely to the examples described above, but that it may be varied within the scope of the claims presented below. Thus, for example, in place of a separate light-attenuating and body-tinted film, the attenuation and graphics needed could be made with a separate color layer, which is printed either on the surface of a separate film or e.g. on the rear surface of the frontmost support plate.

1. Call apparatus and display apparatus of an elevator, which apparatus comprises a body part, which comprises apertures for at least the call buttons and other actuators, wherein the body part is essentially universal such that the number, size, shape and placement location of the apertures of the body are arranged to be suited for the use of more than one display variation and/or call button variation, and in that an essentially thin light-attenuating film-like layer is disposed in front of the body part, which layer is fitted to allow light produced by the display element through, but covers the apertures and other features in the body part.

2. Arrangement according to claim 1, wherein the apertures in the body part that are reserved for the lead-through of the call buttons are essentially elongated in shape and in their lateral direction more than two times longer than the size of the diameter of the call buttons used.

3. Arrangement according to claim 1, wherein the apertures and the fixing holes in the body part that are reserved for the displays are selected by at least their size, shape, number and location to be such that at least all the most common display elements can be fixed singly or together with one or more other display element into the universal body part.

4. Arrangement according to claim 1, wherein the light-attenuating film-like layer is a separate, essentially thin colored film.

5. Arrangement according to claim 1, wherein the film comprises apertures for the call buttons used in the specific elevator application in question.

6. Arrangement according to claim 1, wherein that an essentially transparent support plate is in front of the film.

7. Arrangement according to claim 6, wherein the support plate comprises apertures for the call buttons used in the specific elevator application in question.

8. Arrangement according to claim 1, wherein the light-attenuating film-like layer is printed on the surface of a separate film.

9. Arrangement according to claim 1, wherein the light-attenuating film-like layer is printed on the rear surface of the support plate.

10. Arrangement according to claim 1, wherein the graphics, such as text and/or different patterns and/or different-colored patterns, are printed on the film-like layer.

11. Arrangement according to claim 2, wherein the apertures and the fixing holes in the body part that are reserved for the displays are selected by at least their size, shape, number and location to be such that at least all the most common display elements can be fixed singly or together with one or more other display element into the universal body part.

12. Arrangement according to claim 2, wherein the light-attenuating film-like layer is a separate, essentially thin colored film.

13. Arrangement according to claim 3, wherein the light-attenuating film-like layer is a separate, essentially thin colored film.
